(19) United States
(12) Patent Application Publication
(10) Pub. No.: US 2011/0165426 A1
(43) Pub. Date: Jul. 7, 2011

(54) AQUEOUS SOLUTION FOR BLACKENING CHEMICAL CONVERSION COATING OF ZINC OR ZINC ALLOY SURFACE AND METHOD OF FORMING BLACKENED ANTI-CORROSION COATING FILM USING THE AQUEOUS SOLUTION FOR THE CHEMICAL CONVERSION COATING

(75) Inventors: Shunjiro Watanabe, Yatomi-shi (JP); Yasuhiko Endo, Yokohama-shi (JP)

(73) Assignee: HODEN SEIMITSU KAKO KENKYUSHO CO., LTD., Atsugi-shi (JP)

(21) Appl. No.: 13/119,045

(22) PCT Filed: Sep. 14, 2009
(86) PCT No.: PCT/JP2009/065991

§ 371 Date: Mar. 15, 2011

(30) Foreign Application Priority Data
Sep. 17, 2008 (JP) 2008-238526

(51) Int. Cl. B32B 15/04; C09D 1/00; B05D 1/18; B05D 1/38; B05D 3/00; B05D 3/10

(52) U.S. Cl. 428/446; 106/14.12; 427/435; 427/333

(57) ABSTRACT

The present invention provides a chromium-free surface treating method capable of treating a surface of a metallic member having a surface of zinc or zinc alloy so as to provide good blackness and rust inhibitive performance, and an aqueous solution for chemical conversion coating that can be applied to the treatment method. The aqueous solution contains neither trivalent or hexavalent chromium ion, and contains 5-20 g of phosphate ions per liter, 0.1-3 g of divalent iron ions per liter, 1-10 g of divalent manganese ions per liter, and 1-3 g of nitrate ions per liter. The aqueous solution has a pH of 1-3. A black coating film of Fe₃O₄ is formed by immersing the metallic member in the aqueous solution, then a conversion coating film of cerium oxide is formed thereon, and then a siliceous coating film is formed thereon.

### TECHNICAL FIELD

The present invention relates to an aqueous solution for chemical conversion coating for forming a blackened coating film on the surface of metallic members having a surface of zinc or zinc alloy by using an aqueous solution containing neither trivalent nor hexavalent chromium, that is, a chromium-free aqueous solution, and to a method of forming a blackened anti-corrosion coating film using the aqueous solution for chemical conversion coating.

### BACKGROUND ART

Conventionally, as surface treatment for blackening a surface of a galvanized member, so-called black chromating has been carried out. However, it is being revealed that if a human skin is exposed to a metallic member treated with an aqueous solution of chromate containing hexavalent chromium for a long period, chromium is absorbed by and accumulated in the human body, causing a risk that symptoms such as cancer caused by chromium or chromium allergy may appear.

Under such circumstances, in Europe, according to the RoHS (Restriction of Hazardous Substances) Directive, use of hexavalent chromium is restricted. Surface treatment using trivalent chromium as a substitution for hexavalent chromium has been increased (Patent Literature 10). However, since trivalent chromium is partially converted into hexavalent chromium by an equilibrium reaction, it is feared that trivalent chromium might affect human bodies or environment.

As a chromium-free solution for blackening chemical conversion coating for a galvanized member, a phosphate/nitrate aqueous solution for treating a zinc alloy plated steel sheet (Patent Literature 1), a mixture solution of one or two or more of hydrochloric acid, sulfuric acid, and organic acid and a hydrogen peroxide solution (Patent Literature 2), an acidic aqueous solution having a pH of 6 or less containing a source of sulfite ion and a source of an oxidizable substance (Patent Literature 3), and the like, are known.

Furthermore, a treatment method including: immersing zinc or zinc alloy in an aqueous solution for blackening treatment containing a vanadium ion, an aluminum ion, and an ammonium ion (and a cobalt ion if necessary) ; and treating with a tannin aqueous solution, followed by forming an organic resin coating film has been proposed (Patent Literature 4). In this case, when an organic resin coating film is not formed, a neutral salt spray test shows that rust inhibitive performance lasts for only about eight hours until the occurrence of white rust. Therefore, it is difficult to obtain high rust inhibitive performance in a relatively thin coating film.

Furthermore, a method for chemical conversion coating for a surface plated with zinc or zinc alloy by using an aqueous solution containing hydrogensulfite, aluminum sulfate or gelatin has been proposed (Patent Literature 5). However, the rust inhibitive performance of this method is low. According to a neutral salt spray test, since white rust occurs in 48 hours, it is difficult to say that the method satisfies the practical level of rust inhibitive performance. Furthermore, as a method of treating a chromium-free anti-corrosion coating film for a surface plated with zinc or zinc alloy, a method of forming a coating film of two layers or more has been proposed (Patent Literature 6). However, this literature does not disclose a surface treating method of presenting a black tone. Furthermore, a method of forming surface coating containing corrosion resistant cerium with respect to aluminum or zinc from an acidic aqueous solution containing cerium (Ce) cation and hydrogen peroxide has been known (Patent Literatures 7 and 8, and Nonpatent Literature 1).

The present applicant previously filed a patent application on the invention of a chromium-free surface treating agent for surface-treating a galvanized product, which is an alcoholic solution of an alkoxysilane oligomer with a weight-averaged molecular weight of 1,000 to 10,000 prepared by partially hydrolyzing and condensation-polymerizing tetraalkoxysilane, and has a concentration of the alkoxysilane oligomer in the alcoholic solution of 8 to 25 weight % in terms of silica.(Patent Literature 9).

This chromium-free surface treating agent is characterized in that when it is applied to a galvanized metal product to form siliceous coating film having a thickness of about 1 μm, not only the occurrence of white rust (zinc oxide) that is an indicator of the corrosion resistance of a chemical conversion coating, but also the occurrence of red rust (iron oxide) that is an indicator of the corrosion resistance of a galvanized layer can be prevented for a long period. Citation List

### Patent Literatures

Patent Literature 1: Japanese Patent Application Publication No. 2-17633

Patent Literature 2: Japanese Patent Application Publication No. 4-68392

Patent Literature 3: Japanese Patent Application Laid-Open No. 2003-213446

Patent Literature 4: Japanese Patent Application Laid-Open No. 2005-232504

Patent Literature 5: Japanese Patent Application Laid-Open No. 2006-322048

Patent Literature 6: Japanese Patent Application Laid-Open No. 2008-121101

Patent Literature 7: Japanese Patent Application National Publication No. 02-502655 (WO88/06639A1)

Patent Literature 8: Japanese Patent Application National Publication No. 2003-528218 (U.S. Pat. NO. 6,773,516B2)

Patent Literature 9: Japanese Patent Application Laid-Open No. 2005-264170 (Japanese Patent No. 4128969)

Patent Literature 10: U.S. Pat. No. 5,415,702

### Nonpatent Literature

Nonpatent Literature 1: Kobayashi Y. et al.; Production of cerium-containing chemical conversion coating film on galvanized coating film and evaluation of corrosion resistance of the coating film: Journal of The Surface Finishing Society of Japan, Vol. 55, p.276 (2004)

### DISCLOSURE OF THE INVENTION

### Problems to be Solved by the Invention

Without using hexavalent chromium, blackening treatment using an acidic treatment solution containing a trivalent chromium compound as a chemical conversion coating solution is employed. However, in this treatment, the blackness of a coating film formed on a surface of zinc or zinc alloy is uneven and the rust inhibitive performance is low, and delicate adjustment of treatment solution is necessary. Furthermore, the treatment solution deteriorates fast and needs frequent renewal of the treatment solution. Galvanizers and other related users desire an application method for forming a coating film, which has practical rust inhibitive performance and also has a high quality jet-black tone.

As mentioned above, a conversion treating agent and a surface treating method capable of forming a thin coating film, which is completely chromium-free and has uniform blackness and excellent rust inhibitive performance, on a surface of zinc or zinc alloy, have not been known. Furthermore, proposed chromium-free technologies for substitution of the conventional chromate method are not sufficient in white rust inhibitive performance with respect to complicated-shaped articles of steel-made workpiece, for example, a screwed site or an edged site of bolts and nuts and the like for automobiles and household electric appliances.

An object of the present invention is to provide a method of forming a chromium-free blackened anti-corrosion coating film, which has an excellent rust inhibitive performance equal to or higher than the hexavalent chromate treatment without containing a chromium compound harmful for environment and human bodies in the coating film and which has a self-healing property, that is to say, a property of maintaining the rust inhibitive performance by allowing a coating film component to elute so as to repair the damaged part of the coating film even if an anti-corrosion coating film is damaged, and to provide an aqueous solution for blackening chemical conversion coating suitable for the method for forming the coating film.

### Means for Solving the Problems

In view of the above-mentioned problems, the present inventors have keenly investigated, and, as a result, have obtained a finding that a metallic member having at least three layers of chromium-free coating films on a metallic member having a surface of zinc or zinc alloy, exhibiting excellent blackness and having excellent rust inhibitive performance can be obtained, and have completed the present invention.

These three coating films are formed on a surface of a metallic member having a surface of zinc or zinc alloy by: (A) immersing the metallic member having surface of zinc or zinc alloy in a chromium-free aqueous solution for blackening chemical conversion coating, which contains an iron ion and a manganese ion and contains neither trivalent nor hexavalent chromium ion, so as to form a first layer of a blackened conversion coating film containing triiron tetroxide (Fe₃O₄); (B) then immersing the metallic member in a second aqueous solution for chemical conversion coating containing a trivalent Ce (cerium) ion, so as to form a second layer of a conversion coating film that is a coating film containing cerium oxide on the first layer of the conversion coating film; and then (C) forming a third layer of an anti-corrosion coating film that is a siliceous coating film on the second layer of the conversion coating film.

Note here that the term “comprise” used herein means that additional components may be included. The triiron tetroxide (Fe₃O₄) coating film, the cerium oxide coating film, and the siliceous coating film may consist of triiron tetroxide, cerium oxide and siliceous substances, respectively. Alternatively, the triiron tetroxide (Fe₃O₄) coating film, the cerium oxide coating film, and the siliceous coating film consist essentially of triiron tetroxide, cerium oxide and siliceous substances, respectively, and may contain other additional components as long as they do not substantially affect the function and the property of the coating films. Furthermore, containing of inevitable inclusion materials or impurities may be acceptable. The term “siliceous” means that the content of SiO₂ component is 65 weight % or more and the content of SiO₂ of 100 weight % is included. The content of SiO₂ component of less than 65 weight % makes it difficult to sufficiently obtain desired rust inhibitive performance by the synergistic effect of three layers of coating films.

The first invention is an aqueous solution for blackening chemical conversion coating, for treating a metallic member having a surface of zinc or zinc alloy so as to form a blackened chemical conversion coating film on the surface, wherein the aqueous solution contains neither trivalent nor hexavalent chromium ion, the aqueous solution contains: 5-20 g of phosphate ions per liter; 0.1-3 g of divalent iron ions per liter; 1-10 g of divalent manganese ions per liter; and 1-3 g of nitrate ions per liter; and pH of the aqueous solution is 1-3.

Furthermore, the second invention is a method of forming a blackened chemical conversion coating film on a surface of a metallic member having a surface of zinc or zinc alloy. The method includes immersing the metallic member in the aqueous solution of the first invention, wherein a blackened chemical conversion coating film formed on the surface contains triiron tetroxide (Fe₃O₄).

Furthermore, the third invention is a method of forming a chromium-free, blackened anti-corrosion coating film on a metallic member having a surface of zinc or zinc alloy, the method including: (A) forming a first layer of a blackened conversion coating film on a surface of the metallic member having a surface of zinc or zinc alloy by the method of the second invention, and rinsing the metallic member with water; (B) immersing the metallic member in an second aqueous solution containing 0.3-6.5 g of trivalent cerium ions per liter and having pH of 1-4 so as to form a second layer of a conversion coating film that is a coating film containing cerium oxide on the first layer, and rinsing the metallic member with water; and then (C) applying a surface treating agent containing silica source substance so as to form a third layer of a siliceous coating film on the second layer.

In the third invention, it is preferable that the second aqueous solution containing the cerium ions of the step (B) mentioned above is mixed with an aqueous solution of colloidal silica of such an amount that the second layer includes 1-30 weight % of silica component.

Furthermore, in the third invention, it is preferable that the surface treating agent containing silica source substance of the step (C) mentioned above includes an alcoholic solution containing alkoxysilane oligomer reacted with titanium chelate compound, and the alkoxysilane oligomer has a weight averaged molecular weight of 1,000-10,000.

Furthermore, in the third invention, it is preferable that the thickness of the first layer of a blackened conversion coating film is 0.1-1.0 μm, the thickness of the second layer is 0.1-1.0 μm, and the thickness of the third layer is 0.4-2.0 μm. In the present invention, the thickness of the coating film is a value calculated by taking a microphotograph of a cross-section of the surface treated metallic member and measuring the image of the microphotograph.

In addition, the fourth invention is a metallic member having a surface of zinc or zinc alloy with a black anti-corrosion coating film on the surface including at least three layers, a first layer of a blackened conversion coating film containing triiron tetroxide (Fe₃O₄) on the surface of the metallic member; a second layer of a conversion coating film containing cerium oxide on the first layer; and a third layer of a siliceous coating film on the second layer.

### Effects of the Invention

It is difficult to form a coating film capable of providing excellent blackness and rust inhibitive performance on a metallic member having a surface of zinc or zinc alloy by using a single layer by any methods instead of a conventional black chromating. The present invention provides an aqueous solution for blackening chemical conversion coating for forming a coating film with excellent blackness on the surface of the metallic member. Furthermore, according to the method of forming a blackened anti-corrosion coating film of the present invention, by surface treatment combining forming a first layer of a blackened conversion coating film containing triiron tetroxide (Fe₃O₄), then forming a second layer of a conversion coating film containing cerium oxide on the first layer, and forming a third layer of a siliceous coating film on the second layer, the blackness can be obtained, and at the same time, rust inhibitive performance equal to or higher than that obtained by conventional chromate treatment using hexavalent chromium can be successfully achieved.

### BRIEF DESCRIPTION OF THE DRAWINGS

FIG. 1 is a photograph substituting a drawing of a reflected electron composition image showing a cross section of three layers of coating films formed on a galvanized layer.

### BEST MODES FOR CARRYING OUT THE INVENTION

A metallic member having a surface of zinc or zinc alloy, which is an interest of a method of forming blackened anti-corrosion coating film of the present invention, includes metallic members having a surface of zinc or zinc alloy of electrogalvanized steel products, hot dipping galvanized steel products, vapor deposition galvanized steel products, zinc diecast products, and the like, such as bolts and nuts, press products, sheet materials, and the like. Examples of the metallic members having a surface of zinc alloy include: nickel-zinc alloy plated products and zinc-iron alloy plated products in electrogalvanization, as well as Zn alloy plated products containing Al and Mg in hot dipping galvanization. Other examples include diecast zinc alloy products containing a small amount of Al, Cu, and Mg.

An aqueous solution for blackening chemical conversion coating suitable for the method of forming blackened anti-corrosion coating film of the present invention contains neither trivalent nor hexavalent chromium ion. The aqueous solution contains 5-20 g of phosphate ions per liter, 0.1-3 g of divalent iron ions (Fe²⁺) per liter, 1-10 g of divalent manganese ions (Mn²⁺) per liter, and 1-3 g of nitrate ions per liter. More preferable aqueous solution contains 10-15 g of phosphate ions per liter, 0.3-1.0 g of divalent iron ions per liter, 3-5 g of divalent manganese ions per liter, and 1.5-2.5 g of nitrate ion per liter. Furthermore, pH of the aqueous solution is 1 to 3, and further preferably 1.5 to 2.5.

The aqueous solution for chemical conversion coating of the present invention contains phosphate ion, divalent iron ion, divalent manganese ion and nitrate ion. The surface of zinc or zinc alloy is etched by phosphoric acid in the aqueous solution and activated. On the etched film, a blackened conversion coating film is formed. The component of the blackened conversion coating film substantially includes triiron tetroxide (Fe₃O₄), from the results of EPMA analysis. It is assumed that apart of iron is substituted with manganese. A component contributing to the blackening of the coating film is thought to be mainly iron ion.

A phosphate ion has a function of etching the surface of zinc or zinc alloy and activating thereof. It is not preferable that the phosphate ion in the aqueous solution is less than 5 g/L because etching becomes insufficient, and it is not preferable that the phosphate ion is more than 20 g/L because the surface of zinc or zinc alloy is excessively removed. It is not preferable that the divalent iron ion in the aqueous solution is less than 0.1 g/L because the resultant blackness becomes insufficient, and it is not preferable that the divalent iron ion is more than 3 g/L because sludge is easily generated in the aqueous solution. It is not preferable that the divalent manganese ion in the aqueous solution is less than 1 g/L because the rust inhibitive performance becomes insufficient, and it is not preferable that the divalent manganese ion is more than 10 g/L because the rust inhibitive performance is not improved and excessive divalent manganese ion exists. Furthermore, it is not preferable that the nitrate ion is less than 1 g/L because sufficient black appearance cannot be obtained, and it is not preferable that the nitrate ion is more than 3 g/L because the zinc component on the surface is dissolved, thus deteriorating the rust inhibitive performance, and deteriorating the black appearance.

As the source substance of phosphoric ion, phosphoric acid, manganese phosphate, iron phosphate, and the like, can be used. As the source substance of divalent iron ion, iron(II)sulfate, iron(II)nitrate, ferrous chloride, iron phosphate, and the like, can be used. As the source substance of divalent manganese ion, manganese phosphate (MnHPO₄), manganese nitrate (Mn(NO₃)₂), manganese chloride (MnCl₂), manganese sulfate (MnSO₄), and the like, can be used.

Furthermore, the pH of the aqueous solution for blackening chemical conversion coating is preferably 1 to 3. It is not preferable that the pH is less than 1 because the surface of zinc or zinc alloy tends to be excessively dissolved, and it is not preferable that the pH is more than 3 because divalent Fe ion in the aqueous solution for blackening chemical conversion coating becomes unstable, and tends to be deposited as precipitation. For adjusting the pH of the aqueous solution for blackening chemical conversion coating, phosphoric acid, hydrochloric acid, and sulfuric acid can be used. More preferably, phosphoric acid is used. It is further preferable that the pH of the aqueous solution for blackening chemical conversion coating is adjusted to 1.5 to 2.5 so that the pH is not out of the preferable pH range.

Furthermore, 0.5-2 g/L of cobalt ions may be contained in the aqueous solution. When cobalt ions are contained in the aqueous solution, cobalt is co-deposited in triiron tetroxide, so that the hardness of the blackened conversion coating film can be enhanced.

The aqueous solution for blackening chemical conversion coating to be used for the method of forming blackened anti-corrosion coating film of the present invention is prepared by, for example, dissolving 5-20 g of phosphate ions, 0.1-3 g of divalent iron ions, and 1-10 g of divalent manganese ions in 0.8 liters of purified water, and then adding 2 g of nitrate ions so as to prepare an aqueous solution. To the thus prepared solution, purified water is added so that the total amount of aqueous solution becomes 1 liter. The pH of the aqueous solution, is then adjusted by, for example, adding phosphoric acid thereto.

When a metallic member is immersed in an aqueous chemical conversion coating solution for blackening, the temperature of the aqueous solution may be around room temperature, that is, 5° C. to 40° C. Furthermore, immersion time of the metallic member in the aqueous solution may be such a short period as about 10-60 seconds. When the immersion time is less than 10 seconds, the formation of the conversion coating film is insufficient. When the immersion time is more than 60 seconds, in the case of metallic members plated with zinc or zinc alloy, the plated layer is eroded by phosphoric acid, so that the rust inhibitive performance may tend to be deteriorated. Note here that a blackened conversion coating film having a thickness of about up to 1 μm is formed on the surface of the metallic member after immersion for 30 seconds. After the metallic member is immersed in the aqueous solution, the metallic member is taken out from the aqueous solution, and is then rinsed with water. After the metallic member is taken out from the aqueous solution, the metallic member may be dried or not dried.

The surface of the metallic member on which blackening chemical conversion coating is carried out with the above-mentioned aqueous chemical conversion coating solution for blackening of the present invention is examined by a reflected electron composition image, a blackened conversion coating film having a thickness of about 0.1-1.0 μm and including Fe₃O₄ as a substantial component is formed. The blackness of this blackened conversion coating film corresponds to N 1-1.5 (value of Munsell color system; Munsell value), showing that the surface is very black.

Furthermore, by immersing the metallic member in a second aqueous solution containing trivalent cerium ion, a second layer of a conversion coating film, which is in a tetravalent state, is formed as an intermediate film on the first layer of the blackened conversion coating film.

The thickness of the second conversion coating film was examined by reflected electron composition image of a section. As a result, a presence of a conversion coating film having a thickness of 0.1-1.0 μm and including cerium oxide or hydrated cerium oxide as a essential component was observed. A method itself of forming a coating film of cerium oxide on a surface of zinc or zinc alloy or a surface of aluminum or aluminum alloy is well known as described in BACKGROUND ART. However, in the present invention, the conversion coating film containing cerium oxide is not directly formed on the metallic surface, but the conversion coating film containing cerium oxide is formed as an intermediate film on the first layer of the blackened conversion coating film, and a third layer of a siliceous coating film is further formed thereon on the second layer. Unless this intermediate layer of the conversion coating film is formed between the first layer and the third layer, the metallic member cannot be provided with good rust resistance performance against white rust.

The chemical conversion coating with an aqueous solution containing trivalent cerium ion is carried out after the metallic member blackened with the above-mentioned blackened conversion coating film is rinsed with water. That is to say, the metallic member is blackened with the chemical conversion coating; then rinsed with water; then immersed in an aqueous solution for chemical conversion coating containing about 0.3-6.5 g of trivalent cerium ions per liter, and having pH of 1-4 and a temperature of around room temperature, that is, a temperature of about 5-40° C. for 5-180 seconds; and then rinsed with water.

As the source substance of trivalent cerium ion of the aqueous solution, cerium nitrate, cerium chloride, and the like, can be used. When the pH of the aqueous solution approaches 4, the aqueous solution is deteriorated and it becomes difficult to form a satisfactory coating film containing cerium oxide. Therefore, it is preferable that the increase of the pH of the aqueous solution is suppressed by mixing reductive organic acid, preferably, citric acid.

It is preferable that 1-4 g/L of hydrogen peroxide solution (the concentration of H₂O₂: 30 weight %) is added to 1 L of the aqueous solution containing trivalent cerium ion. The addition of hydrogen peroxide solution promotes the reaction of the chemical conversion coating on the surface of the metallic member, so that the chemical conversion coating can be completed in a short time. When hydrogen peroxide solution is added excessively, the aqueous solution is deteriorated fast.

Note here that it is known that the addition of an appropriate amount of silica fine particles in the coating film containing cerium oxide can improve the rust inhibitive performance against white rust of a metallic member having a surface of zinc or zinc alloy. In the present invention, it is preferable that an aqueous solution of colloidal silica (hereinafter, referred to as “colloidal silica”) is added in an aqueous solution containing trivalent cerium ion so that the rate of the silica component occupied in the second conversion coating film is 1-30 weight %. As the colloidal silica, colloidal silica stabilized at the acidic side, for example, commercially available SNOWTEX-O (registered trademark; manufactured by NISSAN CHEMICAL INDUSTRIES, LTD) can be used.

On the surface of the metallic member, a siliceous coating film having a thickness of 0.4-2 μm, which is observed by the reflected electron composition image of a section, is further formed as a third layer of an upper coating film. Examples of the method of forming the siliceous coating film include various methods. However, it is preferable to use a method using “a chromium-free surface treating agent for surface-treating a galvanized product, which is an alcoholic solution of an alkoxysilane oligomer with a weight-average molecular weight of 1,000 to 10,000 prepared by partially hydrolyzing and condensation-polymerizing tetraalkoxysilane, and has a concentration of the alkoxysilane oligomer in the alcohol solution of 8 to 25 weight % in terms of silica” (Japanese Patent No. 4128969) described in BACKGROUND ART. The weight averaged molecular weight of alkoxysilane oligomer is a value calculated by using gel permeation chromatograph HLC-8120GPC (manufactured by TOSOH CORPORATION) using tetrahydrofuran as a solvent and using a calibration curve based on polystyrene standard.

This surface treating agent has been further improved, a product obtained by combing a titanium chelate compound with alkoxysilane oligomer has been commercially available under the product name of ZECCOAT (registered trademark) ZEC-888 from HODEN SEIMITSU KAKO KENKYUSHO CO., LTD. This compound may be Used.

The titanium chelate compound to be used for improving the surface treating agent is highly active and is reacted to be rapidly bound to alkoxysilane oligomer molecule (liner molecule) as soon as the solution is added to an alcoholic solution of alkoxysilane oligomer, and the molecular weight of the alkoxysilane oligomer molecule is increased by the bound amount. It is preferable that the mixing amount of titanium chelate compound is 2.5-15 atom % with respect to the total amount of silicon in the silica components and titanium in the titanium chelate compound. As the titanium chelate compound, the titanium chelate compound in which the half of the alkoxy groups of tetraalkoxysilane are substituted by a chelate agent such as acetylacetone and octylene glycol is used so that cross-linking reaction of alkoxysilane oligomer molecules does not occur.

As the application of chromium-free surface treating agent for forming the third layer of the coating film on the surface of the metallic member, in the case of small articles such as galvanized bolts and nuts, a dipping and spinning method is employed. When the dipping and spinning method cannot be applied, various methods such as a dipping and draining method, a spray method, and a roll coater method can be used. The application by the dipping and spinning method can provide sufficient rust inhibitive performance by one coating and one baking.

Since low molecular weight alcohol easily evaporates, when the surface treating agent solution is applied to the metallic member and thereafter it is stood still in a room, a dried siliceous coating film can be formed. However, since dew formation may occur according to the gasfication of alcohol, in order to avoid this, it is preferable that the evaporation of alcohol is suppressed by mixing high boiling point alcohol. Preferably, after a surface treating agent is applied to the metallic member, it is baked by heating at 90-150° C. for about 15 minutes. When the baking temperature is low, the rust inhibitive performance of the metallic member is reduced. When the baking temperature is too high, crazing occurs in the siliceous coating film of the surface treating agent, so that peeling easily occurs.

The average thickness of the upper siliceous coating film formed on the surface of the metallic member is made to be 0.4-2 μm. When the thickness is less than 0.4 μm, the rust inhibitive performance is lowered, and even when the thickness is more than 2 μm, the improvement of the rust inhibitive performance is not expected. When the thickness of the coating film is large, the coating film tends to peel off easily. More preferable average thickness of the coating film is 0.5-1.5 μm. The thickness of the siliceous coating film formed on the surface of the metallic member can be selected according to the level of the rust inhibitive performance required for the metallic member having a surface of zinc or zinc alloy.

### EXAMPLES

Hereinafter, the present invention is specifically described with reference to Examples. However, the present invention is not intended to be limited by the following Examples.

### Examples 1 to 3

Hexagon headed bolts (M8×45 half screwed) made of SWCH (carbon steel material for cold forging) were subjected to cyanide-free alkaline bath (CFZ20, manufactured by SURTECMMC Japan) so as to prepare galvanized bolts having a thickness of 8-10 μm. The thus prepared bolts were used as test pieces. Compounds each having mass (g) shown in the upper part of Table 1 were dissolved in purified water sequentially in the described order so as to prepare one liter each of aqueous solution for blackening chemical conversion coating to be used in Examples (1), (2), and (3). In the lower part of Table 1, the content of each ion is shown by the g/L. At the time when all the compounds were dissolved, pH of the aqueous solution was 2. Three test pieces of galvanized bolts were immersed in the aqueous solution for blackening chemical conversion coating at 25° C. for 30 seconds, and then the test pieces were taken out.

TABLE 1
Blackening Chemical Conversion Coating

(g/L)

| | Example 1 | Example 2 | Example 3 |
|---|---|---|---|
| Phosphoric acid 85% | 12.38 | 12.38 | 10.85 |
| Cobalt (II) sulfate | 4.94 | | |
| hexahydrate | | | |
| Manganese (II) phosphate | 8.00 | 8.00 | 15.00 |
| tetrahydrate | | | |
| Iron (II) phosphate | 2.00 | 2.00 | |
| octahydrate | | | |
| Iron (II) sulfate | | | 2.63 |
| heptahydrate | | | |
| Manganese (II) sulfate | | 4.87 | 4.87 |
| hexahydrate | | | |
| Iron ion | 0.53 | 0.53 | 0.53 |
| Nitrate ion | 2.00 | 2.00 | 2.00 |
| Manganese ion | 1.23 | 2.15 | 3.22 |
| phosphate ion | 12.94 | 12.94 | 12.94 |
| Cobalt ion | 1.00 | | |
| Water | Balance | Balance | Balance |
| Immersion time (sec) | 30.00 | 30.00 | 30.00 |

A surface of each test piece had a jet-black surface after water rinsing. The surface of the test piece had a conversion coating film having a thickness of about 0.2 μm when it was examined by reflected electron composition image of a section. When the component of the conversion coating film was examined by EPMA, the component contained Fe₃O₄ as a substantial component. It was assumed that a part of an iron component was substituted by manganese.

Three test pieces that had been subjected to blackening chemical conversion coating were immersed for 1 minute in an aqueous solution for chemical conversion coating at 25° C. mainly containing trivalent cerium ion and colloidal silica (SNOWTEX-O; contains 20% by weight of SiO₂, manufactured by Nissan Chemical Industries, Ltd.) including compositions shown in Table 2, and the test pieces were taken out, then water-rinsed, and then dried.

TABLE 2
Chemical Conversion Coating A*¹

(g/L)

| | |
|---|---|
| Citric acid | 0.20 |
| Cerium nitrate hexahydrate | 3.62 |
| Colloidal silica (*2) | 28.98 |
| Hydrogen peroxide | 1.44 |
| Water | Balance |
| Immersion time (sec) | 60 |

*¹solution for forming cerium coating film
(*2) contains 20% by weight of SiO₂

On the surfaces of the test pieces, the second conversion coating film having a thickness of about 0.3 μm and containing cerium oxide as a substantial component and about 12 weight % of silica component was observed to be formed by the reflected electron composition image of the section of the test piece. Note here that the jet-black first conversion coating film formed on the surface of the test piece remained without reducing the blackness, and the cerium conversion coating film was formed on the first conversion coating film.

Next, three test pieces on which the cerium chemical conversion coating film had been formed were rinsed with water, and dried, followed by applying the above-mentioned chromium-free anti-corrosion surface treating agent for galvanized products (ZECCOAT (registered trademark) ZEC-888) containing an alcoholic solution of alkoxysilane oligomer on the test pieces by a dipping and spinning method. The test pieces were placed in a furnace that had been warmed to 80° C., and the temperature was raised to 100° C. and this temperature was maintained for 30 minutes so as to bake a siliceous coating film. This siliceous coating film was transparent and had an average thickness of about 0.5 μm by the measurement of photograph of the section by the reflected electron composition image.

The above-mentioned chromium-free surface treating agent is commercially available product from HODEN SEIMITSU KAKO KENKYUSHO CO., LTD. (see PCT/JP2007/058137=WO2007/119812A1), and it was prepared as follows. To an isopropyl alcohol solution containing tetraethoxysilane and a small amount of vinyltrimethoxysilane, water and hydrochloric acid were added, and the solution was subjected to partial hydrolysis and condensation polymerization. Thus, an alcoholic solution of alkoxysilane oligomer (weight averaged molecular weight: about 2000) having a content of silica components of about 20 weight % was obtained.

To 52.8 parts by weight of this alcoholic solution, a small amount of titanium chelate compound (TOG manufactured by NIPPON SODA CO., LTD was used), isopropyl alcohol, propylene glycol monomethylether, and others 47.2 parts by weight in total were mixed so as to prepare the agent. The titanium chelate compound is titanium-i-propoxy octylene glycolate in which about half of isopropoxide groups of titanium tetraisopropoxide was blocked (substituted) by octylene glycol (chelate agent).

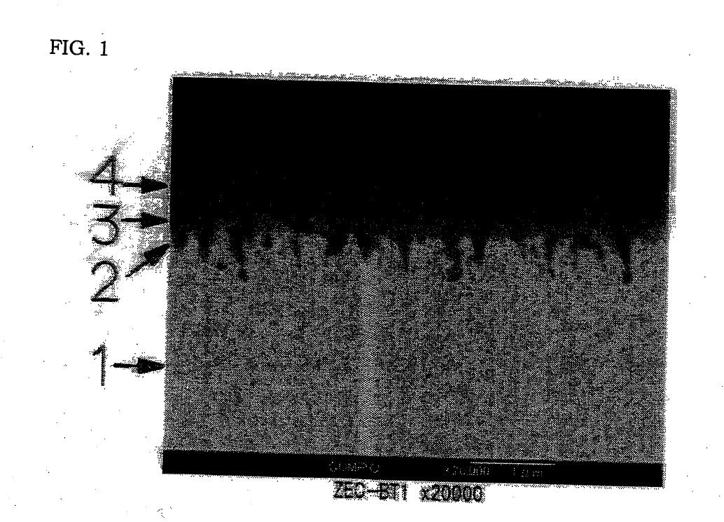

FIG. 1 shows a photograph of a reflected electron composition image of a section of a three-layered coating film formed on a galvanized surface. From FIG. 1, it is shown that the surface of a galvanized layer 1 was etched, a first layer of a blackened conversion coating film 2 was formed on the etched galvanized layer 1, a second layer of a conversion coating film 3 containing cerium oxide as a substantial component was formed on the conversion coating film 2, and a third layer of a siliceous coating film 4 was formed on the conversion coating film 3.

Table 3 shows the rust inhibitive performance and the appearance of the test pieces on which the three coating films were formed when the test pieces were subjected to the neutral salt spray test according to the JIS Z-2371. In all the test pieces of Examples 1 to 3, the appearance was jet-black (shown by ⊙ in Table 3). The times in hours when white rust and red rust occurred (the time when white rust or red rust were observed on the surface of the second test piece among three test pieces that had been treated with the same treatment condition were subjected to the neutral salt spray test) in the neutral salt spray test are shown in Table 3.

TABLE 3
Contents of Treatment, Rust Inhibitive
Performance, and Appearance

| | Example 1 | Example 2 | Example 3 |
|---|---|---|---|
| Cerium coating film | Formed | Formed | Formed |
| Silica coating film | Formed | Formed | Formed |
| White rust occurring time (h) | 144 | 144 | 168 |
| Red rust occurring time (h) | 576 | 600 | 888 |
| Appearance | [symbol] | [symbol] | [symbol] |

White rust occurred when at least 120 hours or more had elapsed, and red rust occurred when at least 500 hours or more had elapsed. Excellent rust inhibitive performance was exhibited. At the same time, excellent black appearance was obtained. As shown in Table 3, the rust inhibitive performance is better in the test pieces of Example 3, which was treated with an aqueous solution for blackening chemical conversion coating containing a larger amount of manganese ions, than the test pieces of Examples 1 and 2.

### Example 4

The same surface treatment was carried out to three test pieces of Zn—Ni alloy plated hexagon headed bolts so as to form three layers of coating films on the surface of the Zn—Ni alloy plated layer as in Example 3 except that three bolts (M8×45 half screwed) were plated with Zn—Ni alloy to the thickness of 8 to 10 μm (co-deposition rate of Ni: about 15 weight %).

### Example 5

The same surface treatment was carried out to three test pieces of Zn—Fe alloy plated hexagon headed bolts so as to form three layers of coating films on the surface of the Zn—Fe alloy plated layer as in Example 3 except that three bolts (M8×45 half screwed) were plated with Zn—Fe alloy to the thickness of 8 to 10 μm (co-deposition rate of Fe: about 0.3 weight %).

As in Examples 1 to 3, the rust inhibitive performance and the appearance of Examples 4 and 5 were evaluated. The results are shown in Table 4. In the evaluation, ⊙ given in the appearance denotes that the appearance was jet-black, and ◯ given in the appearance denotes that the blackness is somewhat deteriorated but it is in a practical level.

TABLE 4
Contents of Treatment, Rust Inhibitive
Performance, and Appearance

| | Example 4 | Example 5 |
|---|---|---|
| Blackening chemical | Same as Example 3 | Same as Example 3 |
| conversion coating | | |
| Cerium coating film | Formed | Formed |
| Silica coating film | Formed | Formed |
| White rust occurring time (h) | 408 | 192 |
| Red rust occurring time (h) | 1920 | 1200 |
| Appearance | ◯ | [symbol] |

### Comparative Example 1 to 3

Chemical conversion coating was carried out respectively by using the galvanized test pieces of hexagon headed bolts (M8×45 half screwed) the same as in Examples 1 to 3 and by using the aqueous solution for blackening chemical conversion coating of Examples 1 to 3. In the three chemical conversion treated test pieces of Comparative Example 1, neither cerium conversion coating film nor siliceous coating film was formed. In Comparative Examples 2 and 3, any one of the surface treatment was not carried out.

The rust inhibitive performance and the blackened appearance of the test pieces are sown in Table 5. All of the test pieces exhibited excellent blackened appearance the same as in Examples 1 to 3. However, in the results of the evaluation of the rust inhibitive performance by the neutral salt spray test, each test piece showed the time of occurrence of white rust was about ⅓ to 1/7 and the time of occurrence of red rust was about 1/12 to ⅓ as compared with that obtained in the rust inhibitive performance of Example 3, showing that the rust inhibitive performance is clearly inferior to that in Example 3.

TABLE 5
Contents of Treatment, Rust Inhibitive
Performance, and Appearance

| | Comparative | Comparative | Comparative |
|---|---|---|---|
| | Example 1 | Example 2 | Example 3 |
| Blackening chemical | Same as | Same as | Same as |
| conversion coating | Example 1 | Example 2 | Example 3 |
| Cerium coating film | Not formed | Formed | Not formed |
| Silica coating film | Not formed | Not formed | Formed |
| White rust occurring time | 24 | 24 | 48 |
| Red rust occurring time | 72 | 168 | 336 |
| Appearance | [symbol] | [symbol] | [symbol] |

### Comparative Example 4 to 6

The test pieces of galvanized bolts were respectively subjected to chemical conversion coating by using the aqueous solution for blackening chemical conversion coating shown in Table 6. Next, similar to Examples 1 to 3, the second and third coating films were formed.

TABLE 6
Blackening Chemical Conversion Coating

(g/L)

| | Comparative | Comparative | Comparative |
|---|---|---|---|
| | Example 4 | Example 5 | Example 6 |
| Phosphoric acid 85% | 12.38 | 12.38 | 12.38 |
| Cobalt (II) sulfate | 4.77 | | |
| heptahydrate | | | |
| Cobalt (II) acetate | | 4.23 | |
| tetrahydrate | | | |
| Cobalt (II) nitrate | | | 4.94 |
| hexahydrate | | | |
| Manganese (II) phosphate | 8.00 | 8.00 | 8.00 |
| tetrahydrate | | | |
| Iron (II) phosphate | 2.00 | 2.00 | |
| octahydrate | | | |
| Iron (II) sulfate | | | |
| heptahydrate | | | |
| Manganese (II) sulfate | | | |
| hexahydrate | | | |
| Iron ion | 0.53 | 0.53 | 0.00 |
| Nitrate ion | 0.00 | 0.00 | 2.00 |
| Manganese ion | 1.23 | 1.23 | 1.23 |
| phosphate ion | 12.94 | 12.94 | 12.33 |
| Cobalt ion | 1.00 | 1.00 | 1.00 |
| Treating time (sec) | 30.00 | 30.00 | 30.00 |

The appearances of the test pieces of Comparative Examples 4 to 6 are shown in Table 7. The solutions for chemical conversion coating of Comparative Examples 4 and 5 do not contain nitrate ion, and the solution for chemical conversion coating of Comparative Example 6 does not contain iron ion. Since any of the Comparative Examples do not satisfy the conditions of the aqueous solution for blackening chemical conversion coating of the present invention, the surface of the test pieces were not blackened.

TABLE 7
Contents of Treatment, Appearance

| | Comparative | Comparative | Comparative |
|---|---|---|---|
| | Example 4 | Example 5 | Example 6 |
| Cerium coating film | Formed | Formed | Formed |
| Silica coating film | Formed | Formed | Formed |
| Appearance | X | X | X |

### INDUSTRIAL APPLICABILITY

When a surface of a metallic member having a surface of zinc or zinc alloy is treated with an aqueous solution for blackening chemical conversion coating of the present invention, the blackness of the coating film corresponds to N 1 to 1.5 (value of Munsell color system), and excellent blackened coating film can be obtained.

In accordance with the present invention, a metallic member having a surface of zinc or zinc alloy on which three layers of coating films are applied has both excellent rust inhibitive performance and preferable black color. The three layers can be obtained by treatment for forming a chromium-free blackened anti-corrosion coating film, which can substitute for conventional blackening chromate or blackening chemical conversion coating using trivalent chromium. From the viewpoint of cost, since the cost required for the invented blackening anti-corrosion coating film formation treatment is competitive as compared with the conventional blackening treatment method using trivalent chromium, and the treatment for forming a blackened anti-corrosion coating film has high industrial usefulness.

Furthermore, a metallic member having a surface of zinc or zinc alloy to which chromium-free blackening anti-corrosion surface treatment was applied according to the present invention, without using a harmful chromium component, exhibits excellent corrosion inhibitive performance that is equivalent to or better than coating film obtained by chromate treatment using hexavalent chromium. Furthermore, self-healing property that is not inferior to the chromate treatment coating film is obtained. Therefore, in particular, it is suitable for formation method of blackened anti-corrosion coating film of metallic members such as bolts and nuts, in which conversion coating film is susceptible to damage.

### DESCRIPTION OF REFERENCE NUMERALS

1 Galvanized layer
2 First layer of conversion coating film
3 Second layer of conversion coating film
4 Siliceous coating film

1. An aqueous solution for blackening chemical conversion coating, for treating a metallic member having a surface of zinc or zinc alloy so as to form a blackened chemical conversion coating film on the surface, wherein
the aqueous solution contains neither trivalent nor hexavalent chromium ion,
the aqueous solution contains:
5-20 g of phosphate ions per liter;
0.1-3 g of divalent iron ions per liter;
1-10 g of divalent manganese ions per liter; and
1-3 g of nitrate ions per liter; and
pH of the aqueous solution is 1-3.

2. A method of forming a blackened chemical conversion coating film on a metallic member having a surface of zinc or zinc alloy, the method comprising:
immersing the metallic member in the aqueous solution according to claim 1,
wherein a blackened chemical conversion coating film formed on the surface contains triiron tetroxide (Fe₃O₄).

3. A method of forming a chromium-free, blackened anti-corrosion coating film on a metallic member having a surface of zinc or zinc alloy, the method comprising:
(A) forming a first layer of a blackened conversion coating film on a surface of the metallic member having a surface of zinc or zinc alloy by the method according to claim 2, and rinsing the metallic member with water;
(B) immersing the metallic member in a second aqueous solution containing 0.3-6.5 g of trivalent cerium ions per liter and having pH of 1-4 so as to form a second layer of a conversion coating film that is a coating film containing cerium oxide on the first layer, and rinsing the metallic member with water; and then
(C) applying a surface treating agent containing silica source substance so as to form a third layer of a siliceous coating film on the second layer.

4. The method of forming a chromium-free, blackened anti-corrosion coating film according to claim 3,
wherein the aqueous solution containing the cerium ions of the step (B) is mixed with an aqueous solution of colloidal silica of such amount that the second layer includes 1-30 weight % of silica component.

5. The method of forming a chromium-free, blackened anti-corrosion coating film according to claim 3,
wherein the surface treating agent containing silica source substance of the step (C) comprises an alcoholic solution containing alkoxysilane oligomer reacted with titanium chelate compound, and the oligomer has a weight averaged molecular weight of 1,000-10,000.

6. The method of forming a chromium-free, blackened anti-corrosion coating film according to claim 3,
wherein the thickness of the first layer of a blackened conversion coating film is 0.1-1.0 μm, the thickness of the second layer is 0.1-1.0 μm, and the thickness of the third layer is 0.4-2.0 μm.

7. A metallic member having a surface of zinc or zinc alloy with a black anti-corrosion coating film on the surface comprising at least three layers,
a first layer of a blackened conversion coating film containing triiron tetroxide (Fe₃O₄) on the surface of the metallic member;
a second layer of a conversion coating film containing cerium oxide on the first layer; and
a third layer of a siliceous coating film on the second layer.
